(19) United States
(12) Patent Application Publication
(10) Pub. No.: US 2025/0312808 A1
(43) Pub. Date: Oct. 9, 2025

(54) SPRAY NOZZLE WITH LAMINAR FLOW CHARACTERISTIC

(71) Applicant: Continental Automotive Technologies GmbH, Hannover (DE)

(72) Inventor: Ota Fejfar, Adrspach (CZ)

(73) Assignee: Continental Automotive Technologies GmbH, Hannover (DE)

(21) Appl. No.: 18/872,373

(22) PCT Filed: May 22, 2023
(86) PCT No.: PCT/DE2023/200104

§ 371 Date: Dec. 6, 2024

(30) Foreign Application Priority Data
Jun. 21, 2022 (DE) 10 2022 206 197.7

(51) Int. Cl. B05B 1/34; B60S 1/52

(52) U.S. Cl. CPC B05B 1/3402; B05B 1/3405; B60S 1/52

(57) ABSTRACT

The invention relates to an improved spray nozzle (1), in particular for a cleaning apparatus in a vehicle, comprising at least one nozzle body (2) with at least one channel (3), wherein the channel (3) extends between an inlet orifice (4) and an outlet orifice (5) and is provided for forming a spray jet (4) from a cleaning fluid, which is ejected from the outlet orifice (4), wherein the channel (3) is helically twisted at least in its portion adjoining the outlet orifice (5).

### CROSS-REFERENCE TO RELATED APPLICATIONS

The present application is a National Stage Application under 37 C.F.R. 371 of International Patent Application No. PCT/DE2023/200104 filed on May 22, 2023, and claims priority from German Patent Application No. 102022206197.7 filed on Jun. 21, 2022, in the German Patent and Trade Mark Office, the disclosures of which are herein incorporated by reference in their entireties.

### BACKGROUND

### 1. Field

Embodiments of the present application relate to a spray nozzle, and more particularly to a spray nozzle with a laminar flow characteristic.

### 2. Description of Related Art

For cleaning optical surfaces on the exterior of a vehicle (for example, glass panes, headlights, camera lenses and the like), a cleaning liquid in the form of a spray jet is usually sprayed under pressure onto the corresponding surface from one or more spray nozzles of an in-vehicle cleaning apparatus. The aim is always to use the limited supply of cleaning liquid as efficiently as possible, while the cleaning apparatus should ideally ensure reliably constant cleaning results under all operating conditions.

It has become common for the spray jet to be formed in a channel in a separate nozzle body, which is inserted into a housing of the spray nozzle. The outdated solutions with circular straight channels, so-called point nozzles, generate a spray jet with a circular cross section, which proves to be less efficient, especially for elongate surfaces such as windshields. Therefore, nozzle bodies with so-called fluidic oscillators with an oscillator channel having a very complex shape were developed, where a spray jet which oscillates or pivots automatically in a plane and which can wet an elongated surface is formed by a skillful use of pressure pulsations and turbulence. With regard to the relevant prior art, reference is made by way of example to WO 2006049622 A1.

However, spray patterns of such spray jets oscillating in the plane are comparatively flat or narrow, and the kinetic energy of such turbulent spray jets is also reduced, which means that stubborn dirt is not removed so effectively. For optimal cleaning of larger surfaces, it is therefore known to combine such oscillators with other, for example point nozzles or to use a plurality of oscillator channels aligned in different planes in one spray nozzle, as is known from DE 102005038292 A1. Such solutions, however, result in higher manufacturing costs and require greater installation space.

Furthermore, such oscillators react sensitively to cold due to their design, when the viscosity of cleaning liquid increases, and this sometimes has a significant negative effect on the complex flow conditions inside and consequently on the resulting spray jet.

### SUMMARY

Aspects and objects of embodiments of the present application provide an improved spray nozzle, which, with a simplified design, efficiently enables stable and effective cleaning results in a wide temperature range.

According to an aspect of an embodiment, there is provided a channel penetrating the nozzle body to be completely helically twisted or to be helically twisted at least in its portion that is adjoining the outlet orifice. A rotational moment generated thereby in the flow within the channel allows a spray jet to propagate with a laminar flow characteristic and a spray pattern or cross section which maps the channel cross section in a scaled manner.

### BRIEF DESCRIPTION OF THE DRAWINGS

Aspects and objects of the embodiments of the present application are explained in more detail in the following text by means of several figure descriptions, in which:

FIGS. 1A and 1B are diagrams illustrating a generic spray nozzle;

FIGS. 2A and 2B are diagrams illustrating a nozzle body in a spatial illustration and in a longitudinal section, respectively, according to an embodiment;

FIGS. 3A, 3B, and 3C are diagrams illustrating a channel according to an embodiment;

FIGS. 4A, 4B, and 4C are diagrams illustrating a spray jet generated by a channel according to an embodiment;

FIG. 5 is a diagram illustrating rotation of the spray jet relative to the outlet orifice according to an embodiment; and

FIG. 6 is a diagram illustrating an aid for calculating the propagation angle of the spray jet according to an embodiment.

### FIG. DETAILED DESCRIPTION OF THE EMBODIMENTS

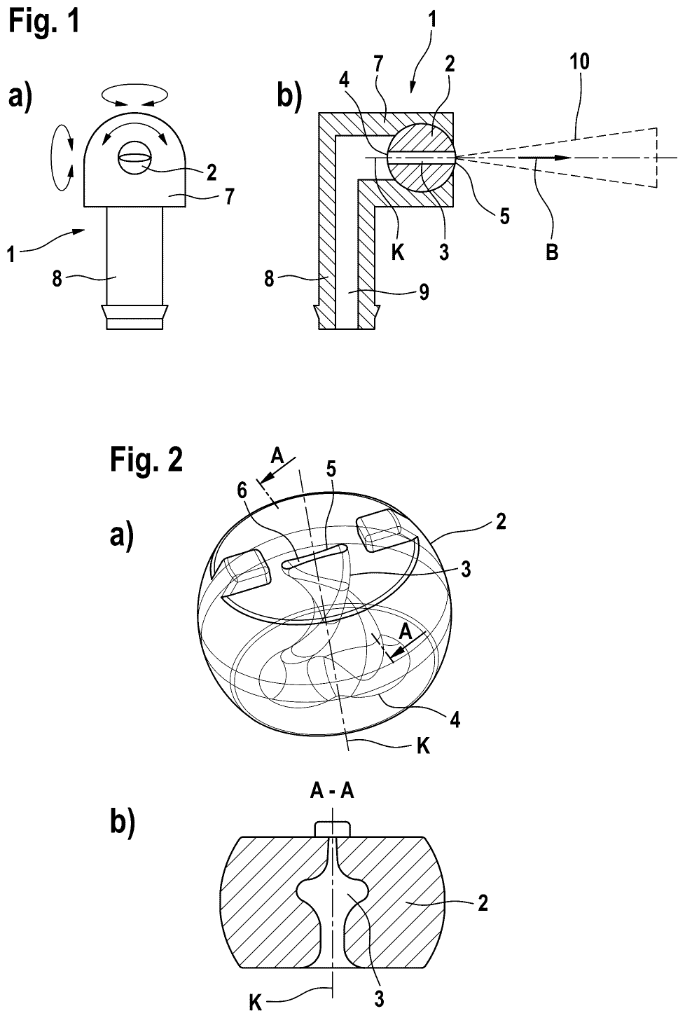

FIG. 1 shows a greatly simplified spray nozzle 1, as is used in particular in cleaning apparatuses in vehicles, for example for cleaning windshields, both in a front view (FIG. 1a) and also in a longitudinal section (FIG. 1b).

A nozzle body 2 with a channel 3 is arranged in a housing 7. The channel 3 extends between an inlet orifice 4 and an outlet orifice 5 through the entire nozzle body 2. A cleaning fluid, for example a cleaning liquid, is supplied under pressure via a supply passage 9. The cleaning fluid enters the channel 3 through the inlet orifice 5, flows through it and is ejected from the outlet orifice 5 in the form of a spray jet 10 in the spray direction B. In the illustrated embodiment, the channel 3 runs along a channel axis K, which also corresponds to the spray direction B, or is parallel thereto.

In the embodiment shown here, the supply passage 9 is formed in a connection piece 8 for connecting a supply line (not shown here). However, other constructive solutions for supplying cleaning fluid to the inlet orifice 4 remain equally permissible within the embodiment.

In principle it is also conceivable that the channel axis K is not consistently linear as shown, but can have a course deviating therefrom, for example is L-shaped. However, it is important that the channel axis K has a linear course at least in a portion adjoining the outlet orifice 5, ideally orthogonal to an imaginary surface spanned by the periphery of the outlet orifice 5.

According to the preferred embodiment principle shown here, the nozzle body 2 is arranged in the housing 7 in a receiving seat with spherical corresponding sealing and contact surfaces such that the nozzle body 2 can be adjusted relative to the housing 7 about all three spatial axes, specifically the vertical axis, transverse axis and longitudinal axis.

Deviating bearing solutions for the nozzle body 2 remain permissible within the embodiment, as does the possibility to form the nozzle body 2 in one piece with the housing 7.

FIG. 2 shows a preferred, adjustment-optimized spherical embodiment of a nozzle body 2 according to the embodiment in a transparent spatial illustration (FIG. 2a) and in a longitudinal section through the channel axis K (FIG. 2b).

The channel 3 turns or twists helically in its course through the nozzle body 2 while continuously tapering. This means that the channel cross section 6 twists along the channel course around the channel axis K, which always runs through the center of the channel cross section 6, wherein the channel cross section 6 or its area is continuously and proportionally reduced along the course. This matter is discussed in more detail below.

The embodiment shown shows a clockwise twist. An opposite direction of twisting, however, would be just as possible.

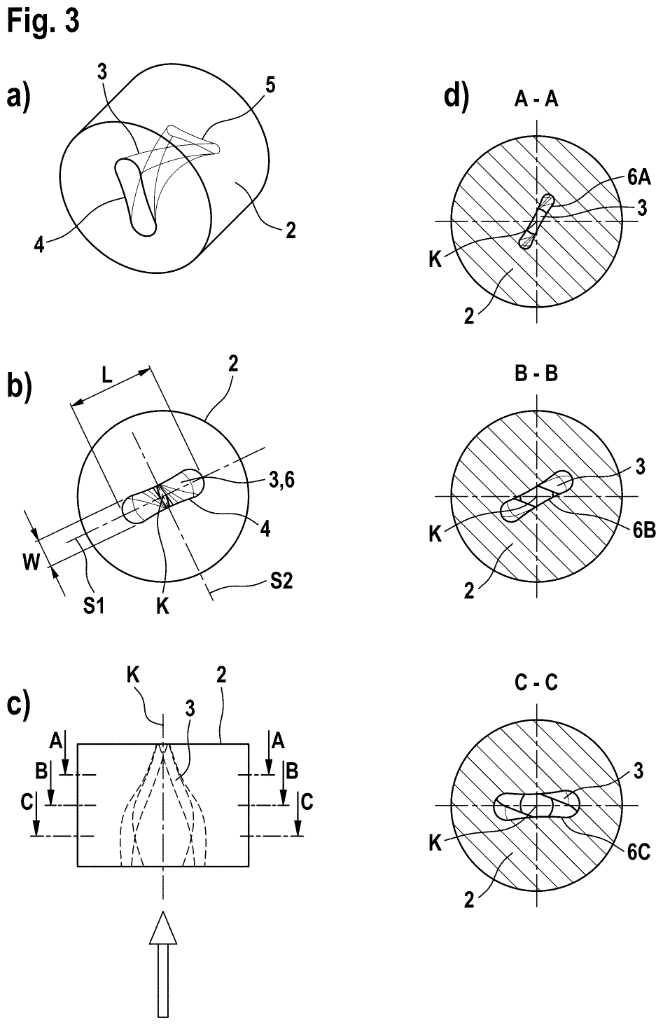

FIG. 3 illustrates the channel course through the nozzle body 2 (shown here only in a simplified manner).

From the view of FIG. 3a it can be seen that the outlet orifice 5 is clearly twisted in a clockwise direction with respect to the inlet orifice 4. This situation can be understood in particular from the view of FIG. 3c and the associated cross sections in the view of FIG. 3d.

The view of FIG. 3b shows the rear of the nozzle body 2 with the inlet orifice 4 in the center. The channel cross section 6 of the channel 3 in the illustrated embodiment, which is especially optimized for windshields, is formed without corners, rounded and elongated with a defined cross-sectional width L and a defined cross-sectional height W. The cross-sectional width L is significantly larger than the cross-sectional height W. In addition, the channel cross section 6 is designed symmetrically to two orthogonal axes of symmetry S1, S2, which intersect at the channel axis K. Avoiding corners in the channel cross section 6 contributes greatly to the reduction of flow losses. Such a cross section in the form of a flattened oval corresponds approximately, for example, to a Cassini curve or a Lamé oval.

The view of FIG. 3c shows the base body 2 in a top view with the indicated series cross sections A, B and C. The arrow shows the direction of flow of the cleaning fluid.

From the cross sections of the view of 3d it is clear that the angular position and the size of the channel cross section 6 are different at different locations (6A, 6B, 6C).

It is clear that the inlet orifice 4 is significantly larger than the outlet orifice 5 and the channel cross section 6 is continuously reduced between the two orifices. Thus, the channel 3 functions as a confuser, which increases the flow speed and thereby also the kinetic energy of the ejected spray jet 10. As a result, range and cleaning efficiency are improved, and the influence of the airstream is reduced.

Here, the profile of the channel cross section 6 does not change along its course despite twisting around the channel axis K and is merely scaled. The profile of the outlet orifice 5 thus corresponds to the reduced profile of the inlet orifice 4 and generally to the profile of the channel cross section 6.

The embodiment is not limited to scaling the profile of the channel cross section 6 along the channel course. It is also possible in further embodiments (not explicitly illustrated here) that the ratio of cross-sectional height to cross-sectional width W/L at the inlet orifice 4 is greater than at the outlet orifice 5, wherein the area of the channel cross section 6 steadily decreases from the inlet orifice 4 toward the outlet orifice 5. The effect as a confuser is maintained in such a channel 3, wherein pressure losses and flow resistance are even smaller compared to the embodiment shown due to less flattening in the inflow region.

It is also obvious that the inlet orifice 5 can be designed for optimization of the flow without sharp edges and instead with a rounded or funnel-shaped mouth region, as it is shown, for example, in FIG. 2.

A nozzle body 2 for cleaning systems is usually made of a thermoplastic material by injection molding in an appropriate injection molding tool. The taper of the channel 3 along its course also simplifies the manufacture of the nozzle body 2, because it acts as a kind of demolding draft and facilitates removal of the nozzle body from the injection molding tool.

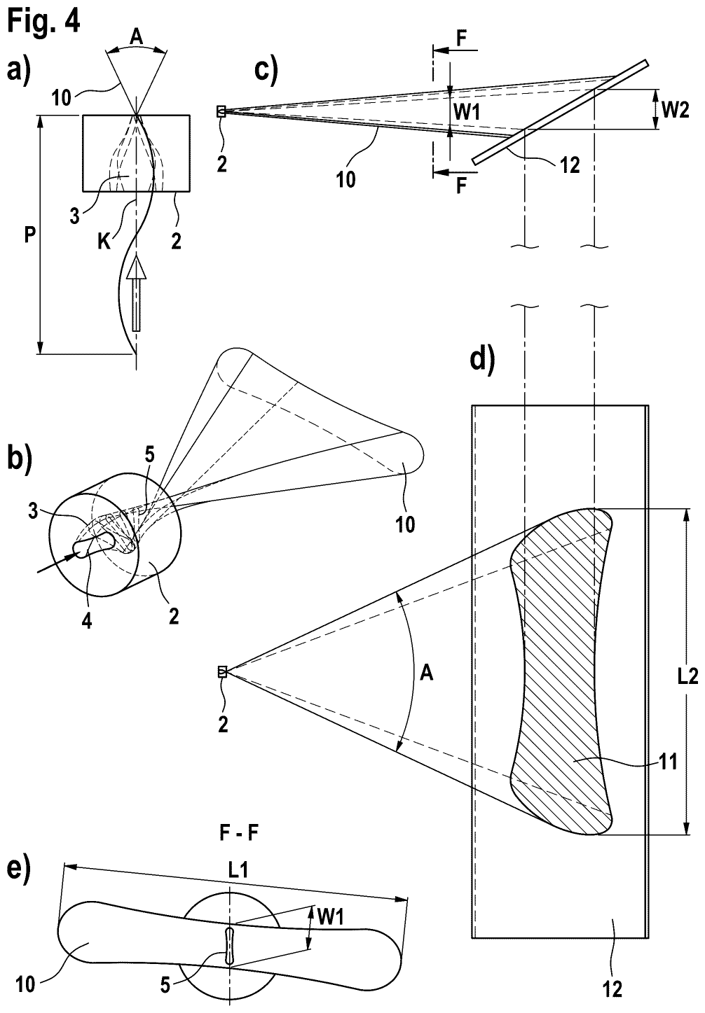

FIG. 4 illustrates the formation or the influence of the helical channel 3 on the spray jet 10. The nozzle body 2 is simplified as in FIG. 3 and shown in a transparent manner.

The view of FIG. 4a shows a top view of the nozzle body 2; the arrow shows the direction of flow of the suppliable cleaning fluid

A section that is required for a complete winding or twisting of the channel cross section 6 by 360° corresponds to a pitch P. The channel cross section 6 does not necessarily have to perform a complete winding along the channel course. A total twisting of the channel cross section 6 between 90 and about 180° is to be assumed to be of practical relevance, wherein deviating values within the embodiment understandably remain permissible.

The view of FIG. 4b visualizes the formation of the spray jet 10.

The cleaning fluid enters the channel 3 under pressure through the inlet orifice 4 and flows through it as a laminar flow. Due to the helical shape of the channel 6 twisting around the channel axis K, the flow within it is given a rotational directional component in addition to the translational one. The cleaning fluid leaves the channel 3 through the outlet orifice 5, wherein the direction at each point of the outlet orifice 5 is tangent to the momentary direction of flow of the cleaning fluid. This leads to the formation of a spray jet 10 which propagates constantly with a propagation angle A. The laminar flow characteristic is retained in the process.

As already indicated above, the ratio of cross-sectional height W to cross-sectional width L along the entire helically twisted channel 3 remains constant

The view of FIG. 4c shows the side view of the spray jet 10 incident on a surface 12, and the view of FIG. 4d shows a corresponding top view. Note that with the described profile of the channel cross section 6, the wetted incidence region 11 on the surface 12 has a very favorable shape for a windshield. In a suitable design, therefore, even a single spray nozzle according to the embodiment would be sufficient to clean an entire windshield, wherein the costs and installation effort of a cleaning apparatus would be significantly reduced.

The view of FIG. 4e shows a perpendicular frontal view of the channel cross section 6 shortly before the incidence on the surface 12. Due to the laminar flow characteristic, all cross sections which are spaced apart from one another in both the channel 3 and the spray jet 10 remain proportional to one another and correspond to one another in scaled form. The following applies at all times:

$$\frac{W}{L} = \frac{W 1}{L 1} = \frac{W 2}{L 2}$$

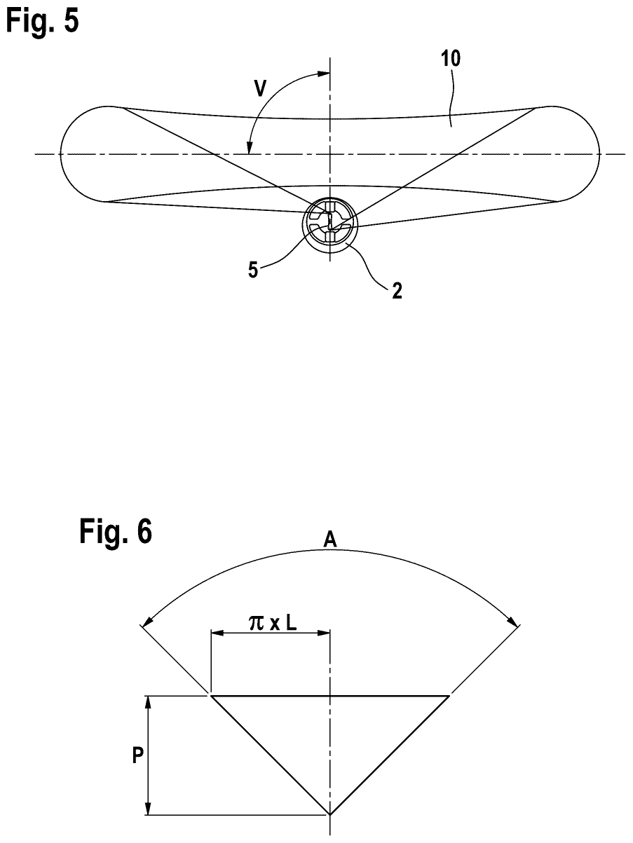

The cross section or the spray pattern of the spray jet 10 corresponds to the scaled channel cross section 6, as already described above, but is twisted in the incidence region 11 about the channel axis K by a twisting angle V in relation to the outlet orifice 5 due to the tangential ejection direction. FIG. 5 illustrates this effect using the example of a particularly practice-optimized design with the twisting angle V of 90°.

The twisting angle V is substantially proportional to the pitch P of the channel 3. In practice, however, a deviation of about 10 to 20% is to be expected due to specific flow effects, which reduces the actual twisting angle compared with its theoretical design.

The theoretical opening angle or propagation angle A of the spray jet 10 can be easily derived from the known cross-sectional width L and the pitch P according to the following formula:

$$A = 2 * arc tg ( π * \frac{L}{P} )$$

In practice, deviations from the theoretical value are possible at the actual propagation angle A, but are usually very small.

The above-described construction principle of the helical channel according to the embodiment is not limited to the above-described application example of a spray nozzle for an in-vehicle cleaning apparatus and can also be used, for example, in industry or other areas for application scenarios when a fluid, in particular liquid, is to be distributed with a defined spray pattern and a laminar flow characteristic.

1. A spray nozzle comprising:
a nozzle body;
an inlet orifice configured to receive a fluid; and
an outlet orifice configured to eject a spray jet of the fluid,
wherein the nozzle body comprises a channel configured to form the spray jet of the fluid, the channel extending between the inlet orifice and the outlet orifice, and
wherein the channel is helically twisted at a position adjacent to the outlet orifice.

2. The spray nozzle as claimed in claim 1, wherein the channel is helically twisted along a channel axis with a defined pitch.

3. The spray nozzle as claimed in claim 2, wherein a channel cross section of the channel is elongated with a defined cross-sectional width and a defined cross-sectional height, and
wherein the cross-sectional width is greater than the cross-sectional height.

4. The spray nozzle as claimed in claim 3, wherein the ratio of cross-sectional height to cross-sectional width is constant in the region of the helically twisted portion of the channel.

5. The spray nozzle as claimed in claim 3, wherein the ratio of cross-sectional height to cross-sectional width is greater at the inlet orifice than at the outlet orifice.

6. The spray nozzle as claimed in claim 5, wherein a surface of the channel cross section is larger at the inlet orifice than at the outlet orifice.

7. The spray nozzle as claimed in claim 6, wherein the surface of the channel cross section is continuously reduced in the direction of the outlet orifice in the region of the helically twisted portion of the channel.

8. The spray nozzle as claimed in claim 7, wherein the channel cross section is rounded without corners with two orthogonal axes of symmetry, substantially as a Cassini curve or a flattened oval or substantially as a Lamé oval.

9. The spray nozzle as claimed in claim 8, wherein the nozzle body is arranged in a housing to be adjustable in relation to at least one spatial axis.

10. The spray nozzle as claimed in claim 9, wherein the nozzle body is arranged to be adjustable relative to the housing.

11. (canceled)
